(19) United States
(12) Patent Application Publication
(10) Pub. No.: US 2015/0034596 A1
(43) Pub. Date: Feb. 5, 2015

(54) GAS-ASSISTED LASER MACHINING

(71) Applicants: Selim Elhadj, Livermore, CA (US); Paul Geraghty, Fremont, CA (US); Michael A. Johnson, Pleasanton, CA (US); Manyalibo Joseph Matthews, Livermore, CA (US); Steven T. Yang, Danville, CA (US)

(72) Inventors: Selim Elhadj, Livermore, CA (US); Paul Geraghty, Fremont, CA (US); Michael A. Johnson, Pleasanton, CA (US); Manyalibo Joseph Matthews, Livermore, CA (US); Steven T. Yang, Danville, CA (US)

(21) Appl. No.: 14/004,873

(22) PCT Filed: Mar. 13, 2012
(86) PCT No.: PCT/US12/28943

§ 371 Date: Aug. 27, 2014

Related U.S. Application Data
(60) Provisional application No. 61/466,382, filed on Mar. 22, 2011.

(51) Int. Cl. C03C 15/00; C23F 1/04; C04B 41/53

(52) U.S. Cl. CPC C03C 15/00; C04B 41/5346; C23F 1/04
USPC 216/65; 156/345.33; 156/345.27

(57) ABSTRACT

A system of gas-assisted laser machining is provided. The system includes a nozzle that delivers a gas jet at the surface of the work piece and a laser source that can focus a laser beam on the surface of the work piece. A mixture of a reactive gas and a carrier gas is provided via the gas jet. The reactive gas reacts with the material and helps to enhance the evaporation rate of the material and at the same time helps reduce the temperature at which the enhanced evaporation rate can be achieved. Use of reactive gases also helps to reduce the residual stress on the material, minimize material flow during evaporation, reduce re-deposited material, and eliminate rims on the pit structures formed as a result of the material removal.

### CROSS-REFERENCES TO RELATED APPLICATIONS

This application claims priority under 35 USC §119(e) to U.S. Provisional Patent Application No. 61/466,382, filed on Mar. 22, 2011, the contents of which are incorporated by reference herein in their entirety for all purposes.

### STATEMENT AS TO RIGHTS TO INVENTIONS MADE UNDER FEDERALLY SPONSORED RESEARCH OR DEVELOPMENT

The United States Government has rights in this invention pursuant to Contract No. DE-AC52-07NA27344 between the U.S. Department of Energy and Lawrence Livermore National Security, LLC, for the operation of Lawrence Livermore National Laboratory.

### BACKGROUND

Conventional forms of laser machining for metals and other types of surfaces use gas to pull the evaporated material away from the surface being machined. Thus, use of gas in conventional machining is merely passive and does not contribute in modifying/enhancing the characteristics of the machining process itself.

It would be beneficial to have a laser machining process that can be enhanced and/or modified using a gas or a mixture of gases.

### SUMMARY

The present invention is generally related to machining of various surfaces. Specifically, embodiments of the present invention relate to gas-assisted laser machining in which a gas (or a mixture of gases) serves to enhance certain aspects of the laser machining process and/or modify certain characteristics of the laser machining process. In a particular embodiment, the gas helps to increase the evaporation/etching rate of the material at a lower temperature than would be needed by conventional process to achieve the same evaporation rate. The type and amount of gas used in the process depends on the type of surface or item being machined worked on.

Gas-assisted laser machining techniques as described herein can impact the surface finish/roughness/quality, by melting, flow, or surface molecular relaxation, even without any significant evaporation (for the duration of the heating). The surface finish, roughness effect can occur because of (a) modification of the surface chemistry and therefore of the interfacial energy, e.g., the tendency for a rough surface to flatten out is greater for greater interfacial energies, (b) modification of the temperature dependence of the interfacial energy driving the Marangoni flow, (c) modification of the local material viscosity, e.g., modification of the OH content of glass due to reaction with Hydrogen, which can diffuse in the bulk and react, and (d) lowering evaporation temperature increases viscosity and reduces material flow, thus reducing rim formation.

Some embodiments of the present invention provide a method for treating a work piece. The method includes providing a work piece having a surface. The method further includes impinging a gas jet on a portion of the surface. In some embodiments, the gas jet includes a reactive gas. Thereafter the method further includes focusing a laser beam on the portion of the surface for a predetermined duration and heating the portion of the surface to a first temperature. The method finally includes removing a predetermined amount of material from the portion of the surface.

In some embodiments, removing the predetermined amount of material from the portion of the surface further includes breaking the bonds between the material molecules due to the heating and evaporating material due to a reaction between the reactive gas and the material. In some embodiments, the method further includes turning off the laser beam upon expiration of the predetermined duration, impinging the gas jet on another portion of the surface, and focusing the laser beam on the other portion of the surface. In a particular embodiment, the work piece is a silica based optical component.

Certain embodiments of the present invention provide a method that includes impinging a gas jet on a surface of a work piece. The gas jet includes a gas that has higher diffusivity than air. The method further includes focusing a laser beam having a first power on the surface for a first duration, heating the surface to a first temperature to remove material from the surface, and moving the removed material away from the surface using the gas. In an embodiment, the gas includes Helium.

An embodiment of the present system provides a system for treating a work piece. The system includes a substrate holder configured to hold a work piece having a surface. The system also includes a nozzle positioned adjacent to the work piece and configured to impinge a gas jet on a desired area of the surface. In a particular embodiment, the gas jet is positioned orthogonal to a plane occupied by the surface of the work piece. The system further includes a laser source configured to emit a laser beam that can be focused at the desired area of the surface. In a particular embodiment, the laser beam passes through the nozzle before impinging on the desired area of the surface. The system also includes a gas delivery mechanism coupled to the nozzle to provide the gas jet. The system is configured to impinge the gas jet on the desired area of the surface, heat the desired area to a first temperature using the laser beam, and remove predetermined amount of material from the desired area. In an embodiment, the gas jet may include Nitrogen, Hydrogen, Helium, air, water vapor, or combinations thereof.

The following detailed description, together with the accompanying drawings will provide a better understanding of the nature and advantages of the present invention.

### BRIEF DESCRIPTION OF THE DRAWINGS

FIG. 1 is a system for performing gas-assisted laser machining according to an embodiment of the present invention.

FIG. 2 illustrates profile of a pit structure with the corresponding spatial temperature profile, formed as a result of the laser machining of a work piece according to an embodiment of the present invention.

FIG. 3 is a graph illustrating the dependence of evaporation rate (R) on gas volumetric flow rates of various gases according to an embodiment of the present invention.

FIG. 4 illustrates the effect of various gases and gas mixtures on the evaporation rate of fused silica according to an embodiment of the present invention.

FIG. 5A is a graph illustrating evaporation data in 100% Nitrogen and air of FIG. 4 re-plotted as the ratio of these evaporation rates (R) in each gas (or a mixture of gases) according to an embodiment of the present invention.

FIG. 5B shows the equilibrium SiO₂ evaporation product, SiO, in the gas near the evaporation site for evaporation in 100% Nitrogen relative to evaporation in air according to an embodiment of the present invention.

FIG. 6 is a flow diagram of a process for treating a surface according to an embodiment of the present invention.

FIG. 7 is a flow diagram of a process for treating a surface according to another embodiment of the present invention.

FIG. 8 illustrates the effect of laser machining techniques described herein on the rim structure according to an embodiment of the present invention.

### DETAILED DESCRIPTION OF SPECIFIC EMBODIMENTS

Certain embodiments of the present invention provide techniques for machining various surfaces using a laser and one or more gases. In some embodiments, the techniques described herein use a laser to heat the surface or area of the surface being machined. A gas or a mixture of gases is used in conjunction with the laser beam to control evaporation rate, etching characteristics, surface shape, and amount of re-deposited material onto the surface being machined. In a particular embodiment, a gas jet is co-incident with the laser beam.

Other embodiments of the present invention provide a system for performing gas-assisted laser machining. The system includes a laser source, a gas delivery system for delivering gas to the area being machined, diagnostic equipment to perform in-situ monitoring of the machining process, material removal sub-system, and a gas source.

Lasers can be used for various machining activities such as drilling, cutting, removing coating of one material from another material, marking/engraving, surface finishing/smoothing, etc. Embodiments of the present invention relate to using a laser to remove a material from a surface of an item. In addition, embodiments of the present invention may be used to in melting, flowing, or surface finishing of material without removal of material. However, the techniques disclosed herein are applicable to any other applications of laser machining. Specifically, embodiments described below relate to removing material from fused-silica based optics components. One skilled in the art will realize that the techniques disclosed herein are equally applicable to laser machining of metals, ceramics, and other types of material.

Silica is used in many industrial applications such as raw material in refractory linings, fiber optics, optical substrates and, in general, as a component in devices requiring inertness and toughness. However, silica is difficult to process. High temperatures above the glass working point (˜2400° K) are used for molding of fused silica, while very reactive species are needed for chemical etching of silica. Furthermore, many of silica's processing properties depend greatly on temperature. In particular, evaporative etching of silica uses extreme temperatures approaching the boiling point of silica, e.g., 3000° K. Such temperatures are not practical for machining under ambient conditions. In applications where localized heating is used for machining glass in air these high temperature requirements often cause unwanted increases in residual stresses, formation of rim structures, and redeposit defects of the glass. A reduction in the treatment temperature for material removal greatly improves thermal processing by reducing and/or eliminating these unwanted factors. In one embodiment of the present invention the laser-driven vapor pressure of silica decomposition products is increased by using reactive gases to assist evaporation.

Until now a systematic study silica behavior near the boiling point of silica was never performed because most containment vessels degrade above □ about 2000° K. Moreover, in-situ measurements of such a process are difficult due to both high blackbody radiation background and high fluxes of heated material. Embodiments of the present invention provide techniques for laser heating a surface to reach surface temperatures of up to 3100° K at the gas-solid interface, and using selected gas reactivities on the evaporation kinetics of silica control and/or modify the etching process. In some embodiments of the present invention, the gases used in the laser machining process include air, water vapor (e.g., humidified air), 100% Hydrogen, a 5% Hydrogen-95% Nitrogen mixture, 100% Nitrogen, 100% Helium, a mixture of Hydrogen and Helium, and combinations thereof. In some embodiments, the etching can be performed in an oxidizing, a reducing, or an inert atmosphere.

Conventional laser machining relies on laser-based evaporation of the material and on the velocity of escaped species within the Knudsen layer close to a hot surface. However, conventional techniques do not include any chemical reactions from a reacting gas, or any shift in the equilibrium of the evaporation reactions from the presence of a gas phase product. In addition in conventional techniques, the gas used for material removal does not react directly with the material during the evaporation process. Embodiments of the present invention provide a laser-based evaporation technique that assumes near-equilibrium conditions within a boundary layer where most of the variation in the species concentration occurs. The equilibrium concentration in the vicinity of the gas-solid interface establishes the driving force for the rate of diffusive transport within the boundary layer before mixing and removal in the bulk of the gas stream. The boundary layer thickness, in turn, depends on the gas properties, flow rate, and flow configuration, and determines the transport kinetics via the mass transport coefficient, hₘ˜D/δ where D is the gas species diffusivity and δ is the boundary layer thickness. In some embodiments, the laser-based evaporation rates for the methods described herein can be obtained through determination of the hₘ and equilibrium constants, Kₚ, from which equilibrium concentrations can be calculated.

Embodiments of the present invention provide methods for laser-based machining in which specific gas phase components are added to enhance the process of evaporation during the heating of a material. In other embodiments, the gas phase components may also help with smoothing of the surface and with the flow of the surface material. The gases are selected so as to lower the evaporation temperature of the material and reduce the laser energy deposited in the material thereby reducing stress on the material.

Many advantages are realized by using the embodiments of the present invention. For example, techniques described herein lower the evaporation temperature for a given evaporation rate of the material and thus etching of material can be performed at reduced temperatures. This lowering in the amount of laser deposited energy as expressed by the temperature of the material, along with the corresponding reduction in the structural modifications of the material helps in reducing stress and residual stress after cooling of the material and increase the materials lifetime, while reducing the extent to which the material will damage in case of failure (e.g. reduced fracture size from smaller stress fields) and also helps in reducing material flow. Another advantage is that reduced laser energy is needed to evaporate/etch the material for a desired etch rate compared to conventional processes. In addition, techniques disclosed herein also help to reduce the amount of the apparent re-deposited material on the surface thus reducing structural and optical defects of the machined surface. Additionally, using reactive gases during the laser evaporation process results in reduction or even elimination of rim formations and curvatures due to Marangoni flow at the heated site edges. This helps to preserve a flatter surface with fewer features that can act to intensify propagated light when the material is used to steer light in optical applications. Similar surface topology and process improvements can be obtained for other materials such as metals, ceramics, etc.

The following embodiments of the present invention are described primarily in relation to fused silica-based material. However, it is to be understood that the embodiments described below are equally applicable to other types of materials such as metals, ceramics, etc. as well.

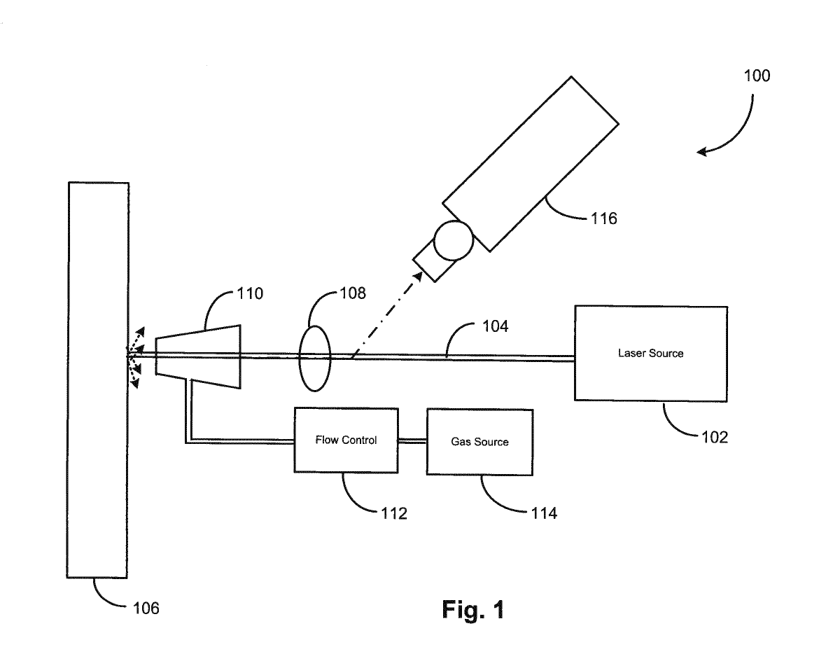

FIG. 1 is a schematic diagram of a system 100 for performing gas-assisted laser machining according to an embodiment of the present invention. System 100 includes a laser source 102 that emits a laser beam 104. Laser beam 104 can be focused on a portion of work piece 106 using a focusing lens 108. A nozzle 110 is positioned such that laser beam 104 passes through the nozzle in order to impinge upon work piece 106. Nozzle 110 is operatively coupled to a gas flow controller 112 and gas source 114. An optional infrared camera 116 or other imaging device may be positioned such that it can monitor the etching process in near real-time conditions. In some embodiments, work piece 106 can be a fused silica-based optical component. Laser source 102 can be a continuous wave (CW) infrared laser or any other suitable laser. In some embodiments, the energy outputted by laser source 102 is about 20 W and laser beam 104 has a wavelength of between 4 μm and 12 μm.

Nozzle 110 includes a laser window (not shown) to allow passage of laser beam 104 through the nozzle, while also forcing the flow through the nozzle front opening where the laser exits. In some embodiments, nozzle 110 may have a 3 mm opening on one end for dispensing the gas or a mixture of gases. The gas jet is impinged normal/orthogonal to the surface plane of work piece 106 and submerges the treated area of work piece 106 well beyond the boundaries of the heated site by displacing the ambient air at the surface of work piece 106 before onset of laser heating. The laser beam passes through the transparent laser window mounted on the backside of nozzle 110 and focuses on the surface of work piece 106. The gas (or mixture of gases) is delivered to the surface of work piece 106 via nozzle 110. In one embodiment, nozzle 110 has a side opening to receive the gas from gas source 114. Temperature measurements can be obtained from infrared imaging of the blackbody radiation emitted during the evaporation process using camera 116. The amount of evaporated silica can be determined from the surface shape profiles obtained by interferometry measurements following treatment of the surface. In some embodiments, gas source 114 may include compressed gas cylinders or a central gas supply cabinet. In some embodiments, the gases used may include dry air (78% Nitrogen, 21% Oxygen, 1% trace gases), 100% Nitrogen, 5% Hydrogen+95% Nitrogen, 5% Hydrogen+95% Helium, 100% Hydrogen, and 100% Helium. Gas flow controller 112 can be used to set the volumetric flow rate of the gases, which can range between 0.2 L/min to about 10 L/min. In some embodiments, the gas flow is started before laser exposure of work piece 106 to insure that all the dead volume is removed from the gas delivery lines and that surface gas submersion of work piece 106 is at steady state.

In an embodiment, laser source 102 can be a Carbon Dioxide (CO₂) laser that emits laser beam 104 having a wavelength of between 10 μm and 12 μm with a maximum output power of 20 W and power stability of about 1% over the duration of the exposure. The diameter of laser beam 104 can be about 1 mm. The laser power delivered to the surface of silica work piece 106 can be between 6.5 W and 7.2 W. In some embodiments, laser beam 104 can be impinged on work piece 106 for about 5 seconds at a time. When laser beam 104 is impinged on surface of work piece 106, the temperature of the surface increases thereby evaporating material at and/or near the location where laser beam 104 is impinged. This results in formation of a pit on the surface of material 106.

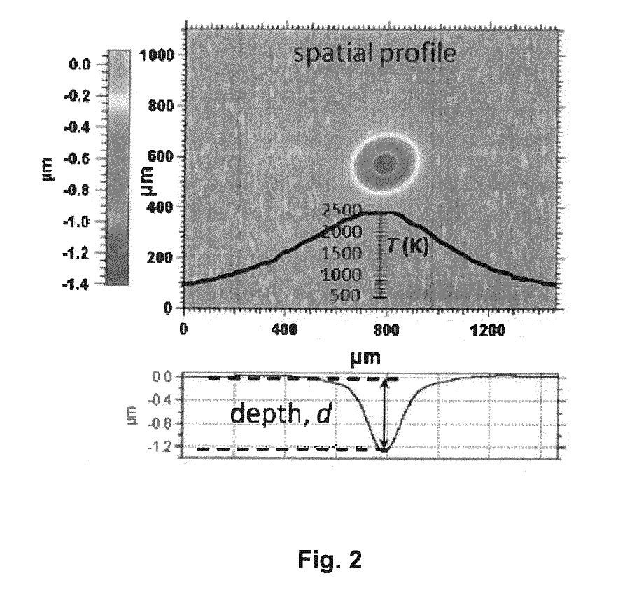

FIG. 2 illustrates pit profile of a pit caused by the laser etching using system 100. As can be seen from FIG. 2, the pit depth d is somewhat proportional to the surface temperature, T(K). Evaporation performed above 3000° K produces deeper pits. In addition, as the Fresnel reflectivity increases, the net laser energy absorption tends to decrease when the aspect ratio of the pit (depth to width) approaches approximately 1. Temperatures between 2000° K and 2500° K produce shallower pits for which the effects on pit depth from the thermally-induced densification of silica may be significant. The resulting surface depressions—distinguishable from those due to evaporation—may be as deep as 100 nm, or about 10% or more of the total pit depth. Below 2100° K, pit depth is dominated by silica compaction. In some embodiments, the evaporation temperature is set between 2000° K and 3100° K.

The temperature and composition dependent evaporation rate, R(T, Cᵢ), can be estimated based on the measurement of the depth profile, e.g., as illustrated in FIG. 2, as it relates to the amount of material removed by evaporation. The accuracy of this approach to derive R depends on the assumption that the depth at a particular location is the result of only the evaporation process, and not the result of flow of molten silica or material expelled from the explosive boiling. This is true at the center of the pit where the pit depth is maximum because there is relatively little contribution of flow-displaced silica to the total depth at the center. The flow velocity, ν_{f}, normal to the surface of the thermocapillary flow can be roughly approximated by

ν_{f}=(dγ/dT)ΔT/μ (1)

where dγ/dT represents the rate of change of the surface tension with temperature, ΔT, is the temperature drop from the center of the pit to the edge of the pit (FIG. 2), and μ is the temperature dependent dynamic viscosity. Thus the calculated contribution of the thermocapillary flow to the total displacement of silica at the center of the pit, v_{f}×ΔT, contributes to no more than 2% of the total pit depth.

In addition, the amount of material removed from drag associated with the gas flow is very low because the gases lack inertia at atmospheric pressure and superficial velocities are small, e.g., <25 m/s. Contributions of vapor-induced shear forces and recoil pressure in shaping laser produced cavities in solids have a negligible impact on the cavity axial depth produced for the relatively slow evaporation conditions. None of the surface profiles display roughening within the pit that would normally occur if explosive boiling had taken place and irradiances are well below the phase explosion threshold, e.g., 10″ W/cm². Therefore, in attributing the axial depth, d, solely to the evaporation of material at that location, the measure of the temperature dependent evaporation rate is given by

R(Tₚ)˜ρ′d/Δt, (2)

where ρ is the fused silica density, Δt is related to the laser exposure time, and T_{ρ} is the peak temperature measured at the center of the pit. Center depth, d, is used because the location of that spot can easily be found from the surface and temperature spatial profiles. Furthermore, restricting the analysis to that location circumvents any ambiguity arising from the non-uniform heating of the Gaussian shaped laser beam. In one embodiment, the effective exposure time, Δt, may be about 4 seconds, since the thermal diffusion time needed to approach peak temperatures with thermal diffusivity D=8×10⁻⁷ m²/s is approximately a²/D=0.98 sec, where a is the beam diameter. The resulting error based on the time-integrated experimental evaporation rates extrapolated to lower temperatures is <3% of the bottom pit depth. Therefore small variations, δ, in the effective exposure time will have negligible impact. Peak temperatures are within 5% of the final peak temperatures reached right before laser turn off for exposure durations greater than the thermal diffusion time, and may increase asymptotically at the rate determined by D and as the heat losses from the work piece balance out the heat input from laser heating.

In some embodiments, the etching/evaporation rate may depend on whether the process is transport limited or based on reaction kinetics control, or both. If the evaporation rate is transport limited, the mass transfer coefficient (hₘ) and the reaction equilibrium constant (Kₚ) are the controlling parameters. If the evaporation rate is not transport limited, the rate constants for the evaporation and condensation reactions are the controlling parameters. If the rate of evaporation (R) is not dependent on the flow rate of the gases, then it can be concluded that the evaporation process is not transport limited. FIG. 3 is a graph that illustrates the dependence of evaporation rate (R) on flow rates of various gases.

As can be seen from FIG. 3, e.g., at a fixed temperature of about 2880° K, as the gas flow increases, so does the evaporation rate. Further, the evaporation rate also depends on the type of gas used. For example as shown in FIG. 3, for a fixed flow of 10 L/min, the rate of evaporation is much higher if 100% Hydrogen is used than if air is used as the gas. As illustrated, there is a correlation between the evaporation rate and the flow rate of the gas being used. However, gas flow rate is not the only controlling parameter for the evaporation rate. The evaporation rate also depends on the type of gas being used. As can be seen from FIG. 3, using 100% Hydrogen results in a much higher evaporation rate than using 100% Nitrogen or air for a given flow rate. This is partly due to the reactive nature of Hydrogen. The transport of the material out of the boundary layer limits the evaporation rate R, since no gas phase reactants are present in pure Nitrogen and air.

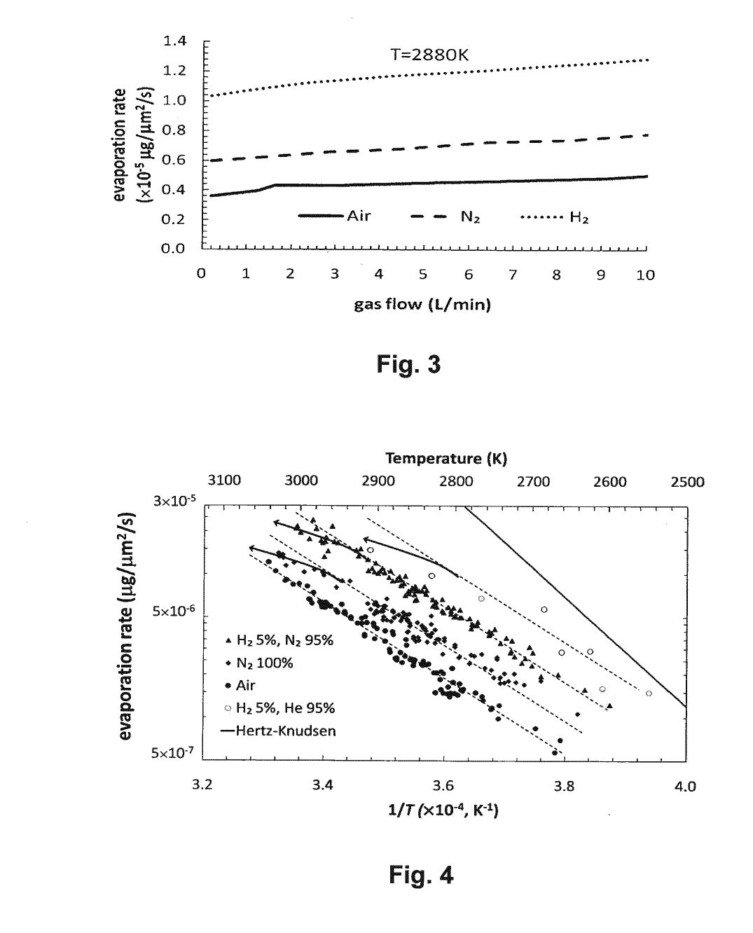

In a particular embodiment, where the treated surface is silica-based, the type of gas used significantly influences the evaporation rate. FIG. 4 is a graph that illustrates the dependence of evaporation rates of silica-based material on the type of gases used. The results of FIG. 4 illustrate the effect of pure Nitrogen, 5% Hydrogen in Nitrogen, and 5% Hydrogen in Helium, among others, on the evaporation rate. One skilled in the art will realize that FIG. 4 is merely exemplary and changing the type of material and/or the gases used will have different effects on the evaporation rate. In some embodiments, the reduction of silica by Hydrogen results in a greater evaporation rate than when the evaporation process is performed in an inert atmosphere using 100% Nitrogen. In addition, 100% Nitrogen results in greater rates than evaporation in air, which is an oxidizing environment. Furthermore, using Hydrogen allows a reduction of 100-200° K in treatment temperature needed to produce the same evaporation rates compared to ambient air conditions.

The main endothermic reactions that occur at the temperatures illustrated in FIG. 4 can be given by

SiO₂(l) [symbol] SiO(g)+½O₂(g) (3)

SiO₂(l)+H₂(g) [symbol] SiO(g)+H₂O(g) (4)

Reaction (3) is the main decomposition reaction that occurs when any of the gases illustrated in FIG. 4 are used. Reaction (3) represents the effect of heat in breaking the bonds of silica in our example. The secondary reaction (4) occurs only when Hydrogen is added in the gas mixture. The addition of Hydrogen provides an additional pathway for the evaporation of silica, which is confirmed by the increased rate of evaporation in the presence of Hydrogen, as illustrated in FIG. 4. The presence of Oxygen during the evaporation process also affects the rate of evaporation. Evaporation in air is lower compared to evaporation in pure Nitrogen due to the presence of Oxygen. Second, the Oxygen that is a byproduct of reaction (3) slows evaporation by shifting the equilibrium of reaction (3) backward. As the evaporation temperature increases so does the amount of Oxygen released during the reaction thereby further slowing the rate of evaporation.

As can be seen from FIG. 4, for pure Nitrogen and a combination of Hydrogen and Nitrogen, evaporation rate R becomes sub-linear at higher temperatures, e.g., above ˜2900° K, as indicated by the arrows and dashed lines. The change in the rate of evaporation, R, is less apparent in air because of the already elevated amount of Oxygen present in air (about 21%). Thus, in air, the Oxygen produced in reaction (3) above does not alter the overall concentration of Oxygen significantly as indicated by the linearity of R up to the highest temperatures. If maximum evaporation rates predicted from the Hertz-Knudsen equation,

R=Pₛₐₜ(T)√(2πmk_{B}T) (5)

where Pₛₐₜ is the vapor pressure of SiO in reaction (3), in is the molecular mass, and k_{B} is the Boltzmann constant, are compared to the rates illustrated in FIG. 4, it can be seen that the predicted rates are 2-3 orders of magnitude greater. For example, some sample predicted rates as illustrated in FIG. 3 are 9×10⁻⁴ μg/m²/s at a temperature of 2850° K, and 1.5×10⁻⁴ μg/m²/s at a temperature of 2620° K. This is because the Hertz-Knudsen model does not account a priori for the mass transport limitations of the process using the gases described above. Also, the contrasting temperature dependence and slope in FIG. 4 reflect the fact that the Hertz-Knudsen formula is derived from the kinetic theory of gases, which scales the escape velocities as 1/√T, while the temperature dependence of the near-equilibrium for embodiments described herein depends on the thermodynamics of the evaporation process and, to a lesser extent, on the temperature dependence of the transport kinetics.

In an embodiment, Helium can be used instead of Nitrogen as the carrier gas along with the same Hydrogen fraction of 5%. Thus the gas combination in this embodiment would be 95% Helium and 5% Hydrogen. The magnitude of the rate of evaporation R in Helium is larger because the gas phase diffusivity in Helium is larger than in Nitrogen. This results in a greater hₘ and R in Helium in the case where mass transport is the limiting transport mechanism. As illustrated in FIG. 4, an increase in R is observed when Helium is used as the carrier gas. Thus, in some embodiments, the process of laser based evaporation as described herein is mass transport limited. In the transport limited regime, the molar evaporation rate can be approximated as a function of the mass transfer coefficient and the equilibrium SiO concentration, [SiO]_{eq}. Thus, for a given a product-free gas feed, the rate of evaporation can be determined as

R˜hₘ[SiO]_{eq} (6)

In order to perform a quantitative analysis of the evaporation rates illustrated in FIG. 4, it may be useful to calculate the equilibrium species concentration based on the temperature dependent reaction equilibrium constant (Kₚ). The reaction equilibrium constant (Kₚ) is given by the free energy of reaction (3) and (4) above.

Kₚ=exp(−ΔGᵢ°/R_{c}T) (7)

Where R_{c} is the gas constant and T is the temperature for reaction i. Thus, for the overall system, the reaction equilibrium constant can be determined as

Kₚ₁(T)=((nᵢ₋ₛᵢₒ+ξ+α)/n_{T})*((nᵢ₋₀₂+½ξ)/n_{T})^{0.5}*P^{3/2} (8)

Kₚ₂(T)=((nᵢ₋ₕ₂−α)/n_{T})⁻¹*((nᵢ₋ₛᵢₒ+ξ+α)/n_{T})*((n_{i-H2O}+α/)n_{T})+P (9)

The terms in parenthesis represent mole fractions. P is the total pressure taken at 1 atm in the system, nᵢ are the initial species quantity in moles, α and ξ are the extent of reaction for each reaction, n_{T} represents the total number of moles calculated based on the nᵢ, α and ξ. Standard free energies, ΔG°, are generally known in the art and may be found in thermodynamic databases.

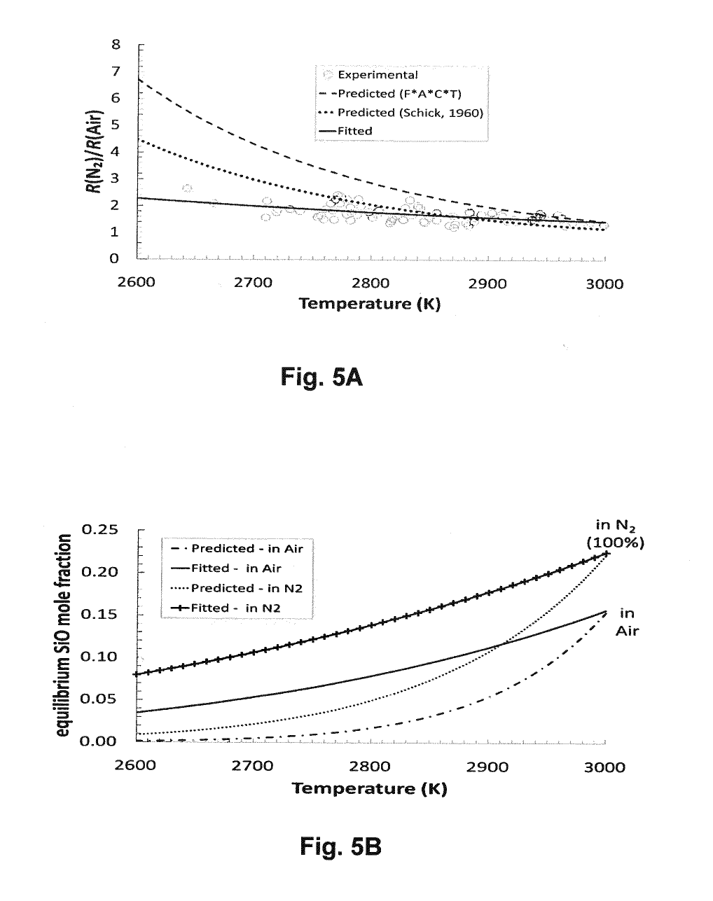

FIG. 5A is a graph illustrating evaporation data of FIG. 4 re-plotted as the ratio of the evaporation rate R in each gas according to an embodiment of the present invention. Data in FIG. 5A can be compared directly to the calculated equilibrium concentrations or, equivalently, to mole fractions. The implied approximation that hₘ (in air) is approximately equal to kₘ (in N₂) is reasonable because the selected gases have Nitrogen as their main constituent ranging from 80% to 100%, thus the transport properties of the gas mixtures are expected to be similar. FIG. 5B shows a comparison of the experimental ratio of R for evaporation in Nitrogen relative to air with the two curves representing the ratio calculated from Eq. (8) and the ΔG° for reaction (3) reported from two sources according to an embodiment of the present invention. The corresponding calculated equilibrium SiO mole fractions are provided in FIG. 5B with predicted values determined from ΔG°. The predictions agree with the data at higher temperatures, however, at lower temperatures there is a slight discrepancy between the two predictions shown as dashed lines in FIG. 5B. However, the discrepancy is within the spread in the data and thus not material.

In embodiments where Hydrogen is used in the gas mixture, there is a difference in the experimental versus calculated ratios of R (e.g., H₂ mixture vs. pure N₂). Using an initial 5% Hydrogen fraction, the calculated Hydrogen concentration equilibrates locally to values between 0.5% and 2.5% for temperatures ranging from 2600° K to 3000° K, respectively. The mass transport of Hydrogen is fast enough to maintain a bulk Hydrogen concentration throughout the gas-solid interface where it is being consumed in reaction (4). This is consistent with the finding that the transport of the products, and not the reactants, is rate limiting. Thus a fixed 5% Hydrogen concentration, along with the derived ΔG° can be used to determine R and to calculate the predicted ratio. In contrast with the R_{N2}(T)/Rₐᵢᵣ(T) ratio in FIG. 5A, the R_{H2}(T)/R_{N2}(T) ratio is greater than the predictions and it improves at higher temperature where the conditions for near-equilibrium are more closely approximated as was the case for the air/Nitrogen case. The fact that the calculated R_{H2}(T)/R_{N2}(T) ratio is greater than predicted from equations (8)-(9) indicates that the evaporation rates in Hydrogen are greater than expected relative to evaporation rates in pure Nitrogen. One reason is that the Hydrogen also reacts with the Oxygen evolving from reaction (3), thereby pushing the reaction forward to produce the greater than expected silica evaporation rates in Hydrogen. Hydrogen may react both with silica directly (e.g., reaction (4)) and with Oxygen in a third reaction to form water vapor (e.g., H₂(g)+½O(g)=H₂O(g)). The thermal decomposition of silica in reaction (3) may also take place concurrently. All these different reactions lead to a greater evaporation rate when Hydrogen is used as the reactive gas in the gas mixture.

A complete expression of the absolute R includes the determination of not only the equilibrium SiO concentrations, but also of the mass transport kinetics expressed in the hₘ. The hₘ can be extracted from the data by fitting across the two process variables on which R depends, e.g., temperature and flow rate. Equation (6) can now be written as

R(T,V)=hₘ(T,V)′[SiO]_{eq}(T) (10)

where V is the gas volumetric flow rate and the [SiO]_{eq}(Y) is determined for each gas from the fitted reaction free energies. For this purpose, generalized expressions describing the kinetics of transport using a boundary layer approximation are useful. Typically used are the dimensionless Sherwood number, Sh, which relates Sh to the Reynolds, Re, and the Schmidt number, Sc. Sh is defined such that

Sh=hₘL/D=f(Sc=μ/ρD,Re=ρVL/μ) (11)

where L is a characteristic length (taken as the beam diameter), μ is the dynamic viscosity, D is the species diffusivity, and ρ is the gas density. All the temperature dependent gas properties can be calculated from (a) available data and empirical models to extrapolate the viscosity, diffusivity, and (b) from the ideal gas law for density. The particular form of the empirical expression for hₘ is given by:

Sh=□C*Sc^{m}*Reⁿ (12)

where C, in, and n represent a single set of fitting parameters applicable for all the gases described herein.

Thus, using the determined hₘ and the equilibrium concentration calculated from Kₚ, the laser-based evaporation behavior of silica can be determined, which accounts for the temperature dependent gas properties, the thermodynamics of the reaction of the gas phase reactant, and the mass transport configuration in the flow system. The methods described herein are applicable to a broad range of materials exposed to both steady state heating with lasers and to gases with selected reactivities. As described above, the laser-based evaporation is a process that is mass transport limited and therefore dependent on the thermodynamics of the reactions through the free energy. The techniques described herein can enable the derivation of thermodynamic properties of gas-solid phase reactions at extremes temperatures, provided that accurate measurement of the evaporation rates and temperatures are made. The techniques can also help understand the mechanism by which specific gases interact with the solid during reactive etching and can improve control of thermal etching processes in general.

In some embodiments, adding certain gases during the evaporation process can significantly help to enhance the evaporation process as described above. In a particular embodiment, the gas jet can be impinged normal to the surface plane of the work piece. The gas jet is impinged before beginning the evaporation/etching process such that the portion of the surface being treated is submerged in the gas well beyond the boundaries of the heated site by displacing and replacing the ambient air at the surface being treated. The laser beam passes through the nozzle and is focused on a portion of the work piece surface. Laser exposure time and surface temperature can be controlled by controlling the laser pulse length, laser power level, laser operating mode, beam shape, etc. and gas composition. In some embodiments, the laser exposure time can be between 0.5 seconds to about 5 seconds with a power of up to 20 W.

As discussed above, a variety of gases or combinations thereof may be used to submerge the surface being treated. Using a mixture of 5% Hydrogen (or any other reducing gas such as carbon monoxide (CO), hydrogen fluoride (HF), some organic compounds, etc.) in a carrier gas such as Nitrogen or Helium results in a 5-10 fold increase in the evaporation rate compared to ambient air. In the instance where 100% Hydrogen is used, an additional 10 fold increase in evaporation rate at a given temperature and transport conditions may be realized relative to air. In addition, the increase in the evaporation rate is achieved at temperatures lower than that required for ambient air. As described above, the rate of removal depends on the type of gas or gas mixture used and the type of environment that a given gas mixture creates at or near the surface to treated. Using Helium increases the evaporation rate compared to Nitrogen due to the greater diffusivity of product and/or reactants in Helium relative to other carrier gases such as Nitrogen, thus increasing mass transport through boundary layer resistance near the surface being treated. Similarly, using a reducing gas increases the evaporation rate compared to using an inert gas or an oxidizing gas because the additional solid silica reactive pathway from the reducing agent increases the evaporation product gas concentration within the boundary layer near the surface, increasing thus the driving force (concentration gradient) and the diffusive mass transport through the boundary layer.

In addition, using techniques described herein results in reduced amounts of small particles that may re-deposit onto the surface being treated. One reason for this is that since the majority of the removed material is carried away from the surface being treated rapidly by convective transport, there is very little material left that can be re-deposited on to the treated surface. Also, gas, induced changes in the surface chemistry may re-melt the re-deposited material on the surface more easily to produce a less rough surface.

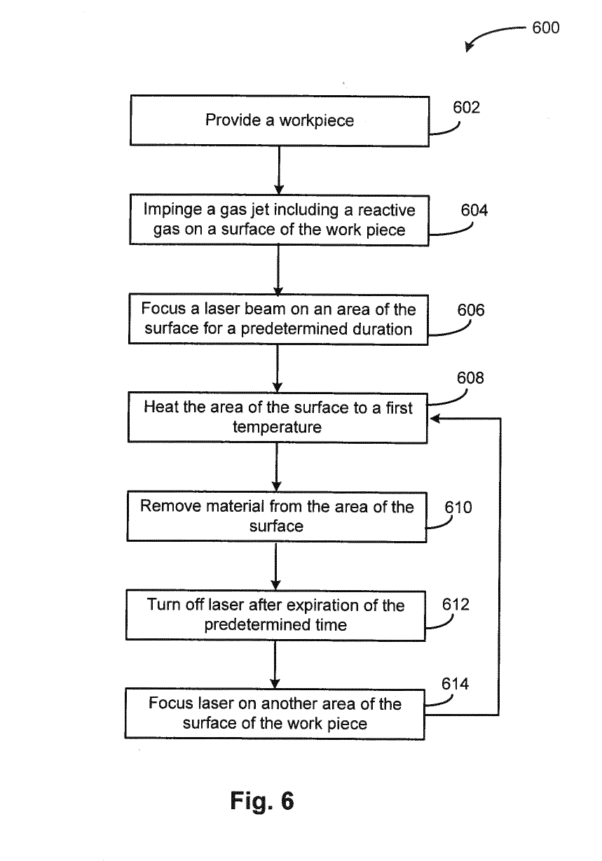

FIG. 6 is a flow diagram of a process 600 for treating a surface using any of techniques described herein according to an embodiment of the present invention. Process 600 can be performed using, e.g., system 100.

Initially a work piece is provided (602). In an embodiment, the work piece can be silica based optical component. Thereafter a gas jet is impinged on a surface of the work piece (604). In some embodiments, the gas jet may include a mixture of a reducing gas and a carrier gas. A laser beam is then focused on an area of the surface for a pre-determined duration (606). In some embodiments, the gas jet and the laser beam are co-incident. Subsequently, the area of the surface is heated to a first temperature (608). In some embodiments, the first temperature can be between 2000° K and 3100° K. The increase in temperature results in the breaking of the bonds of the silica material and the gas reacts with the silica material to evaporate the material as described above (610). After a predetermined amount of material is removed and/or after the pre-determined duration has elapsed, the laser beam is turned off (612). Thereafter the laser beam is focused on another area of the surface (614) and the process is repeated.

It should be appreciated that the specific steps illustrated in FIG. 6 provides a particular method of treating a surface according to an embodiment of the present invention. Other sequences of steps may also be performed according to alternative embodiments. For example, alternative embodiments of the present invention may perform the steps outlined above in a different order. In some embodiments, there may be no significant evaporation/removal of material at all (i.e. no step 610) but rather only melting and reflow of material to provide for a smoother surface finish. Moreover, the individual steps illustrated in FIG. 6 may include multiple sub-steps that may be performed in various sequences as appropriate to the individual step. Furthermore, additional steps may be added or removed depending on the particular applications. One of ordinary skill in the art would recognize many variations, modifications, and alternatives.

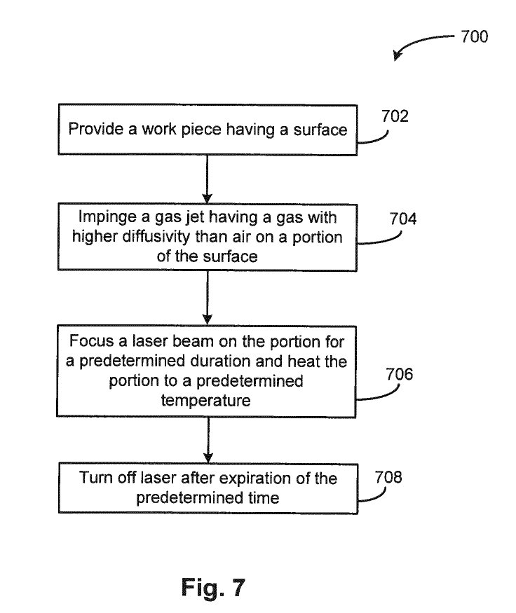

FIG. 7 is a flow diagram of a process 700 for laser machining of a surface according to an embodiment of the present invention. Process 700 can be performed, e.g., by system 100 of FIG. 1.

A work piece having a surface is provided (702). A gas jet is impinged on a portion of the surface that is to be treated (704). The gas jet includes a gas that has higher diffusivity than air and/or is lighter than air, e.g., Helium. The portion of the surface is then heated using a laser beam for a predetermined duration (706). As the material is removed from the surface, the gas jet helps to carry the removed material away from the surface. Upon expiration of the predetermined duration, the laser beam is turned off (708).

It should be appreciated that the specific steps illustrated in FIG. 7 provides a particular method of treating a surface according to an embodiment of the present invention. Other sequences of steps may also be performed according to alternative embodiments. For example, alternative embodiments of the present invention may perform the steps outlined above in a different order. Moreover, the individual steps illustrated in FIG. 7 may include multiple sub-steps that may be performed in various sequences as appropriate to the individual step. Furthermore, additional steps may be added or removed depending on the particular applications. One of ordinary skill in the art would recognize many variations, modifications, and alternatives.

In an embodiment, the techniques disclosed herein can be used for damage mitigation of silica-based optical components. Silica-based optical components that are used in conjunction with lasers suffer from optical damage due to prolonged exposure to laser fluence. In particular, optical components, such as lenses, windows, etc. are prone to damage when exposed to high-power, high-energy laser irradiation. All optical materials will ultimately damage at sufficiently high laser intensities through processes intrinsic to the optical material. Such intrinsic optical damage is the result of high-energy deposition through multi-photon ionization and is determined by the material's bulk electronic structure. Such damage normally occurs at intensities in excess of 200 GW/cm². In practice, however even the highest quality optical components can damage at fluences well below their intrinsic damage threshold.

Photoactive impurities in the near surface layer of the silica-based optical component can absorb high-intensity light thus transferring energy from the beam into near surface of the optical component raising the local temperature. If the combination of the intensity of the laser beam and the strength of the absorption are sufficient, a small local plasma can ignite on the surface of the optical component. Such plasma may itself absorb energy from the light beam further raising the local temperature until the end of the termination of the light pulse. Physically, the damage is a manifestation of the plasma including melted material, ejecta, and thermally induced fractures. This results in pitting of the surface thereby degrading the optical component. Techniques described herein can be used to treat the damaged sites of such optical components.

For example, a gas jet including a reducing gas can be impinged on the surface of a damaged optical component and a laser beam applied to remove the material from the damaged area and generally smooth out the damaged area. Every optical component has certain tolerance level for such mitigation of damaged areas. However, as described in relation to FIG. 2 above, such laser ablation damage repair creates a pit at the damaged site. Usually, the rim associated with such a pit structure can be a source of optical distortion and light intensification; hence it is beneficial to have a very low profile, smaller rising rim, or having no rim at all to reduce any light focusing. The rim is caused due to melting and flow of material (e.g., due to Marangoni flow) and/or re-condensation of the material at the damage site. However, by using techniques disclosed herein the rim of the pit can be greatly reduced or eliminated as can be seen in FIG. 2, thereby eliminating possible sources of optical distortion and optically induced damage. The elimination of the rim is achieved because the temperatures needed for removing the material are lower than conventional processes, which reduce the likelihood of material flow through higher viscosity and Marangoni drive-flow and since majority of the material is carried away from the surface by the gas jet, it leaves less material that can be re-deposited on the surface and which could potentially contribute to the rim structure or its roughness.

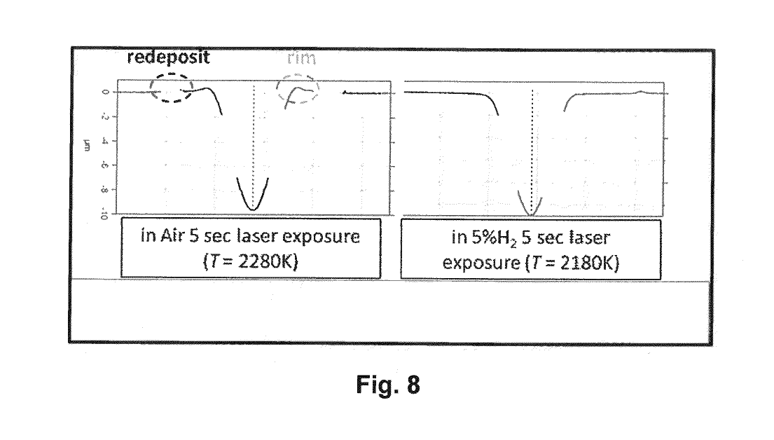

FIG. 8 illustrates the effect of laser machining techniques described herein on the rim structure according to an embodiment of the present invention. As illustrated in FIG. 8, for the same evaporation levels (i.e. depth of pit), using a 5% Hydrogen 95% Nitrogen gas mixture, no apparent rim was observed, while in ambient air, a rim of about 0.2 μm around the pit was observed. It should be noted that for the same etching level, the measured rim and re-deposition are absent for conditions of 5% hydrogen gas, while achieving reductions in the amount of energy absorbed in the silica.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method comprising:
providing a work piece having a surface;
impinging a gas jet on a portion of the surface, the gas jet including a reactive gas;
focusing a laser beam on the portion of the surface for a predetermined duration;
heating the portion of the surface to a first temperature; and
removing a predetermined amount of material from the portion of the surface.

2. The method of claim 1 wherein the gas jet and the laser beam are co-incident.

3. The method of claim 1 wherein removing the predetermined amount of material from the portion of the surface further comprises:
breaking the bonds between the material molecules due to the heating; and
evaporating material due to a reaction between the reactive gas and the material.

4. The method of claim 1 further comprising:
turning off the laser beam upon expiration of the predetermined duration;
impinging the gas jet on another portion of the surface; and
focusing the laser beam on the other portion of the surface.

5. The method of claim 1 wherein the work piece comprises a silica-based material.

6. The method of claim 1 wherein the reactive gas includes a reducing gas.

7. The method of claim 6 wherein the reducing gas comprises one or more of hydrogen, carbon monoxide, water vapor, or hydrogen fluoride.

8. The method of claim 1 wherein the gas jet further comprises a carrier gas.

9. The method of claim 8 wherein the carrier gas comprises at least one of nitrogen or helium.

10. The method of claim 1 wherein the predetermined duration is between 0.5 seconds and 5 seconds.

11. The method of claim 1 wherein the first temperature is in the range of between 2000° K to about 3100° K.

12. A method comprising:
impinging a gas jet on a surface of a work piece, the gas jet including a gas that has higher diffusivity than air;
focusing a laser beam on the surface for a first duration, the laser beam having a first power;
heating the surface to a first temperature to remove material from the surface; and
moving the removed material away from the surface using the gas.

13. The method of claim 12 wherein the gas comprises helium.

14. The method of claim 12 wherein the gas jet is impinged on the surface prior to focusing the laser beam on the surface.

15. The method of claim 12 wherein the work piece comprises silica.

16. The method of claim 12 wherein the first power is about 20 W and the first duration is between 0.5 seconds and 5 seconds.

17. A system comprising:
a substrate holder configured to hold a work piece having a surface;
a nozzle positioned adjacent to the work piece and configured to impinge a gas jet on a desired area of the surface, the gas jet being positioned orthogonal to a plane occupied by the surface of the work piece;
a laser source configured to emit a laser beam that can be focused at the desired area of the surface, wherein the laser beam passes through the nozzle before impinging on the desired area of the surface;
a gas delivery mechanism coupled to the nozzle to provide the gas jet,
wherein the system is configured to:
impinge the gas jet on the desired area of the surface;
heat the desired area to a first temperature using the laser beam; and
remove predetermined amount of material from the desired area.

18. The system of claim 17 further comprising a temperature sensor configured to continuously monitor temperature at the desired area while the material is being removed.

19. The system of claim 17 wherein the gas jet comprises nitrogen, hydrogen, helium, air, water vapor, or combinations thereof.

20. The system of claim 17 wherein the gas jet comprises one of: a mixture of 5% hydrogen and 95% nitrogen or a mixture of 5% hydrogen and 95% helium.

21. The system of claim 17 wherein the laser source comprises an infrared laser.
